(19) United States
(12) Patent Application Publication
(10) Pub. No.: US 2025/0358272 A1
(43) Pub. Date: Nov. 20, 2025

(54) SIGNING OF CERTIFICATES FOR ON-PREMISE DEVICES

(71) Applicant: Honeywell International Inc., Charlotte, NC (US)

(72) Inventors: Blake Puhak, Richmond, VA (US); Nicholas Dodd, Brighton (GB); Walter Scott Hoye, Henrico, VA (US); Melanie Rose Coggan, Henrico, VA (US); William B Smith, Colonial Heights, VA (US); Eric Anderson, Madison, WI (US)

(21) Appl. No.: 18/668,316

(22) Filed: May 20, 2024

(51) Int. Cl. H04L 9/40

(52) U.S. Cl. CPC H04L 63/0823

(57) ABSTRACT

Techniques for obtaining signed certificates for on-premise devices are described. A system for obtaining signed certificates for on-premise devices includes an on-premise device and a certificate management device. The on-premise device includes a set of services for establishing communication with the on-premise device. Each service requires a certificate signed by a certificate authority for establishing secure communication with the on-premise device. A request for obtaining the signed certificate corresponding to each of the set of services is received and analyzed by the certificate management device. The request is processed based on the analysis to obtain an output for the request corresponding to each of the set of services. The output includes a signed certificate of a corresponding certificate authority along with an expiration period or a message to reject issuing of a signed certificate. The output for the request is sent to the on-premise device.

### BACKGROUND

Generally, industries or organizations include, manufacturing plants, warehouses, and factories, that may employ devices, such as sensors, controllers, automation systems, data servers, and the like., for various purposes. For instance, an automotive industry may include Internet of Things (IoT)-based sensors for fleet management, IoT-based sensors to monitor performance metrics of the automobile, one or more controllers to control one or more IoT-based devices, and the like. An industrial plant for manufacturing a component may include an automation controller to automate one or more processes corresponding to the manufacturing of the product, a controller to set manufacturing parameters corresponding to the manufacturing of the product and/or to monitor operating environment of the product, and the like. In this regard, such IoT-based devices and the controllers may communicate with other IoT-based devices, communicate with one or more controllers, communicate with one or more cloud servers, and the like. For instance, a controller of an industrial plant may communicate with a cloud server to transmit data corresponding to a manufactured product for obtaining insights into the product manufacturing process at a later point in time.

To enable communication with other devices or cloud servers, each of the on-premise devices may include different services. For instance, a controller may include a web server which enables HTTPS communication to that controller (for example, to connect to the controller from a web browser).

### SUMMARY

In the present subject matter, a system for obtaining signed certificates for on-premise devices includes an on-premise device and a certificate management device. The on-premise device may include a set of services. Each service may correspond to establishing communication with the on-premise device. For instance, the service may be a web server to enable running of a web page on the on-premise device. The service may be, for example, a Fox protocol server to enable an on-premise Niagara device to communicate with another on-premise Niagara device. In yet another example, the service may be a platform management service to enable communication regarding management of an operating system corresponding to the on-premise device. In another example, the service may be an external communication service to enable communication of the on-premise device outside the system.

Each service may require a signed certificate signed by a certificate authority for establishing secure communication with the on-premise device. The certificate management device may be in communication with the on-premise device. The certificate management device may receive a request for obtaining a signed certificate corresponding to each of the set of services.

Initially, the on-premise device may have to be on-boarded with the certificate management device to request a signed certificate. In this regard, prior to receiving the request for obtaining the signed certificate, the on-premise device may send an on-boarding request. The on-boarding request may be authenticated using an identification code. Subsequently, the authorization is established with the on-premise device upon successful authentication.

The request may include a set of parameters indicative of type of certificate and a unique identifier corresponding to the on-premise device. The certificate management device may process the request based on the analysis to obtain an output for the request corresponding to each of the set of services. The output may include either a signed certificate along with an expiration period or a message to reject issuing of a signed certificate in response to the transmission of the request. The output, either the signed certificate or the message regarding rejection, may be sent to the on-premise device. If the output includes the signed certificate, the on-premise device may store the signed certificate along with the expiration period and update configuration to present the signed certificate for communication.

Instead of transmitting the request to a corresponding certificate authority, the certificate management device may process the request from the on-premise device itself. The certificate authority may run a certificate signing service that can sign the requested certificates and transmit the signed certificate to the on-premise device. In this regard, the certificate management device may include a plurality of local certificate authority certificates (known to the certificate management device) that are signed by a certificate authority's root certificate. Accordingly, upon receiving the request from the on-premise device, the certificate management device may sign the requested certificate using the signing service of the certificate management device or reject signing of the certificate and transmit the output message.

In an example, if the output includes the signed certificate along with the expiration period, the certificate management device may receive a request for renewal of the signed certificate corresponding to the service before a predetermined period of time prior to the expiration period. The certificate management device may analyze the request for renewal of the signed certificate corresponding to the service in response to receiving the request for renewal of the signed certificate corresponding to the service. Further, the certificate management device may process the request for renewal of the signed certificate corresponding to the service. In an example, the certificate management device may use the signing service, to generate the output for the request for renewal. For instance, the certificate management device may generate the renewed signed certificate along with a new expiration period or a message to reject renewal of the signed certificate. Further, the certificate management device may send the output for the request for renewal to the on-premise device.

In an example, the present subject matter also allows to use the signed certificate until a grace period after the expiration period is elapsed, while the process of obtaining the renewal is taking place. The present subject matter enables obtaining and renewing a signed certificate for a plurality of services for a plurality of on-premise devices.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a system for obtaining signed certificates for an on-premise device, according to an example implementation of the present subject matter;

FIG. 2 illustrates a system for obtaining signed certificates for on-premise devices, according to an example implementation of the present subject matter;

FIG. 3 illustrates a system for obtaining signed certificates for on-premise devices, according to an example implementation of the present subject matter;

FIG. 4 illustrates a certificate management device, according to an example implementation of the present subject matter;

FIGS. 5a-5b illustrate a method for obtaining signed certificates for on-premise devices, according to an example implementation of the present subject matter;

FIG. 6 illustrates a method for renewing signed certificates for on-premise devices, according to an example implementation of the present subject matter;

FIGS. 7a-7b illustrate a method for obtaining signed certificates for on-premise devices, according to an example implementation of the present subject matter;

FIGS. 8a-8b illustrates a computing environment, implementing a non-transitory computer-readable medium for obtaining signed certificates for on-premise devices, according to an example implementation of the present subject matter.

### DETAILED DESCRIPTION

Generally, various devices, such as Internet-of-things (IoT)-based sensors, IoT-based controllers, IoT-based cameras, and the like, installed on premises of organizations (i.e., at a location of the organizations) may communicate with each other and/or with one or more cloud servers. Accordingly, each of these on-premise devices may include various services for establishing communication with other on-premise devices and/or cloud servers.

The communication with the on-premise devices may be susceptible to interception for malicious purposes, such as man-in-the-middle (MITM) attacks. Accordingly, a certificate may have to be obtained from and signed by appropriate certificate authority to ensure secure communication between these devices. A certificate includes a public key and is associated with a private key that corresponds to the public key. The public key is bound to a record of an owner of the public key. The certificate's public key and the private key are stored separately. The certificate includes a digital signature from a certificate authority. Generally, a certificate includes various information, such as a public key, information about the organization that issued the certificate, expiry period for the certificate, usage of the certificate, such as for authentication of a server, and the like, and a digital signature by the certificate authority certificate's private key. Various certificates, such as Secure Sockets Layer (SSL), Transport Layer Security (TLS), and the like are commonly used for providing secure communication and to prevent malicious attacks in the communication.

Each of the on-premise devices may include different services for establishing communication with the on-premise devices. Each of these services may require a certificate to be signed by appropriate certificate authority for establishing secure communication. For instance, a web server supported on a controller may require a SSL certificate. Further, another web server supported on the controller may require a Transport Layer Security (TLS) certificate. Accordingly, each on-premise device may need to obtain a plurality of signed certificates from different certificate authorities.

The process for obtaining a signed certificate includes various steps. For instance, a certificate request from a device will have to be generated. The certificate will have to be signed by a certificate authority for the certificate to be valid. The signed certificate chain may have to be imported into the device that generated the request. This process may have to be repeated for each service that requires a signed certificate. Accordingly, the process of obtaining signed certificates can be cumbersome and time consuming especially when it needs to be done multiple times for different services using the same certificate or for multiple certificates on the same device.

Further, conventionally, each of the certificates used to be valid for a few years. However, owing to increased security awareness and to provide better security, lately, the certificates are having validity of about a year or less. Accordingly, upon the expiry of the validity, to continue communication and/or to enable secure communication, the certificates will have to be renewed. The process of renewal includes similar steps as the process of obtaining the certificate initially. The process of renewal of the certificates on a periodic basis is cumbersome and time-consuming. Further, in some scenarios, users of these devices may have to manage and keep track of the expiration of these certificates. Accordingly, as the number of certificates increases, the tracking of the expiration period becomes difficult, and the user may miss out renewing one or more certificates. As a result, in some scenarios, the communication between the devices may not be established and/or the communication between the devices may not be secure. Therefore, conventionally, a lot of effort is required by a user, such as a systems integrator, to obtain signed certificates initially and to renew on a periodic basis. Accordingly, the process of obtaining and renewing signed certificates is difficult, cumbersome, expensive, and time-consuming.

The present subject matter relates to obtaining signed certificates for on-premise devices. In accordance with the present subject matter, process of obtaining and renewing signed certificates for a plurality of services for on-premise devices is simplified and easy and thereby, the present subject matter enables secure communication of the on-premise devices.

The present subject matter relates to obtaining signed certificates for on-premise devices. With the present subject matter, one or more on-premise devices may communicate with a certificate management device connected in a common object model framework, such as a Niagara Framework. Particularly, the present subject matter enables the on-premise devices to send all the certificate signing requests required by the on-premise devices. All these certificate signing requests are collected by the certificate management device. The certificate management device processes the certificate signing requests and creates the signed certificates correspond to each of the certificate signing requests. The certificate management device then transmits the signed certificates to the appropriate on-premise devices. Similarly, the centralized device also enables renewing the certificates using a similar process, as will be described below.

In accordance with the present subject matter, a system for obtaining signed certificates for on-premise devices may include an on-premise device and a certificate management device. The certificate management device may be in communication with the on-premise device. The on-premise device may include a set of services. Each service may correspond to establishing communication with the on-premise device. For instance, the service may be a web server to enable running of a web page on the on-premise device. The service may be, for example, a Fox protocol server to enable an on-premise Niagara device to communicate with another on-premise Niagara device. In yet another example, the service may be a platform management service to enable communication regarding management of an operating system corresponding to the on-premise device. In another example, the service may be an external communication service to enable communication of the on-premise device outside the system.

Each service may require a signed certificate signed by a certificate authority for establishing secure communication with the on-premise device. The signed certificate may be an X.509 certificate for use as a client certificate and a X.509 certificate for use as a server certificate. The certificate management device receives a request for obtaining a signed certificate corresponding to each of the set of services.

Initially, the on-premise device may have to be on-boarded with the certificate management device to request a signed certificate. In this regard, prior to receiving the request for obtaining the signed certificate, the on-premise device may send an on-boarding request. The on-boarding request is authenticated using an identification code. Subsequently, the authorization is established with the on-premise device upon successful authentication.

The request may include a set of parameters indicative of type of certificate and a unique identifier corresponding to the on-premise device. The certificate management device may analyze the request for obtaining the signed certificate corresponding to each of the set of services. The certificate management device may process the request based on the analysis to obtain an output for the request corresponding to each of the set of services. The output may include a signed certificate along with an expiration period. In another example, the output may include a message to reject issuing of a signed certificate. The output, either the signed certificate or the message regarding rejection, is sent to the on-premise device. If the output includes the signed certificate, the on-premise device may store the signed certificate along with the expiration period and update configuration to present the signed certificate for communication.

In an example, the certificate management device may process the request from the on-premise device itself. In this regard, the certificate management device may include a plurality of local certificate authority certificates (known to the certificate management device). Each local certificate authority certificate may be a root certificate authority certificate or a certificate signed by a root or intermediate certificate authority that may be configured to be used for signing other certificates. In an example, the certificate management device may be a local certificate authority where rather than signing with a certificate from a root certificate authority, the certificate management device may sign with a locally generated certificate that is trusted by all the on-premise devices the certificate management device signs certificates for. The certificate management device may include a signing service for signing a certificate. The request corresponding to each of the set of services may be processed by the certificate management device using at least one of the plurality of local certificate authority certificates. The certificate management device may generate the output (of either the signed certificate along with the expiration period or the message to reject issuing of the signed certificate) by using the signing service. Upon the generation, the output may be sent to the on-premise device.

In an example, if the output comprises the signed certificate along with the expiration period, the certificate management device may have to be renewed prior to expiration. In order to renew the certificate, the certificate management device may authenticate a request for renewal. The authentication may be done using a token, such as a JavaScript Object Notation (JSON) web token. In response to a successful authentication, the certificate management may receive the request for renewal of the signed certificate corresponding to the service. The certificate management device may receive a request for renewal of the signed certificate corresponding to the service upon sending the signed certificate along with the expiration period to the on-premise device. The request may include a set of parameters corresponding to the service. For instance, the set of parameters may indicate the type of certificate required and a unique identifier corresponding to the on-premise device. The request for renewal of the signed certificate may be received before a predetermined period of time prior to the expiration period.

The certificate management device may analyze the request for renewal of the signed certificate corresponding to the service in response to receiving the request for renewal of the signed certificate corresponding to the service. The request for renewal of the signed certificate corresponding to the service may be processed by the signing service of the certificate management device. The output of a signed certificate along with a new expiration period or a message to reject issuing of the signed certificate may be generated by using the signing service. The certificate management device may send the output for the request for renewal to the on-premise device.

In an example, the present subject matter may enable obtaining and renewing signed certificates for a plurality of on-premise devices. In this regard, a first request for obtaining a signed certificate corresponding to each of a first set of services may be transmitted from a first on-premise device. The first on-premise device may include the first set of services. Each of the first set of services may correspond to establishing communication with the first on-premise device. Each of the first set of services may require a signed certificate signed by a certificate authority for establishing secure communication with the first on-premise device. The first request may include a first set of parameters corresponding to each of the first set of services being indicative of type of certificate and an unique identifier corresponding to the first on-premise device.

Similarly, a second request for obtaining a signed certificate corresponding to each of a second set of services may be transmitted from a second on-premise device. The second on-premise device may include the second set of services. Each of the second set of services may correspond to establishing communication with the second on-premise device. Each of the second set of services may require a signed certificate signed by a certificate authority for establishing secure communication with the second on-premise device. The second request may include a second set of parameters corresponding to each of the second set of services being indicative of type of certificate and an unique identifier corresponding to the second on-premise device.

The certificate management device may receive the first request for obtaining the signed certificate corresponding to each of the first set of services and the second request for obtaining the signed certificate corresponding to each of the second set of services. The certificate management device may be in communication with the first on-premise device and the second on-premise device.

The certificate management device may process the request from the on-premise device itself. In this regard, the certificate management device may include a plurality of local certificate authority certificates (known to the certificate management device). Each local certificate authority certificate may be a root certificate authority certificate or a certificate signed by a root or intermediate certificate authority that may be configured to be used for signing other certificates. In an example, the certificate management device may be a local certificate authority where rather than signing with a certificate from a root certificate authority, the certificate management device may sign with a locally generated certificate that is trusted by all the on-premise devices the certificate management device signs certificates for. The certificate management device may include a signing service for signing a certificate. The first request corresponding to each of the first set of services and the second request corresponding to each of the second set of services may be processed by the certificate management device using at least one of the plurality of local certificate authority certificates using the signing service. The certificate management device may generate an output for the first request and for the second request by using the signing service.

The output may include a signed certificate along with an expiration period or a message to reject issuing of a signed certificate in response to the transmission of the request. Upon the generation, the output may be sent to the corresponding on-premise device. In other words, the output for the first request corresponding to each of the first set of services may be transmitted to the first on-premise device and the output for the second request corresponding to each of the second set of services may be transmitted to the second on-premise device. In an example, the first on-premise device may request the output for the first request corresponding to each of the first set of services to the first on-premise device. In response to the request by the first on-premise device, the output for the first request corresponding to each of the first set of services may be transmitted by the certificate management device to the first on-premise device.

Similarly, in an example, the second on-premise device may request the output for the second request corresponding to each of the second set of services to the second on-premise device. In response to the request by the second on-premise device, the output for the second request corresponding to each of the second set of services may be transmitted by the certificate management device to the second on-premise device.

In an example, prior to transmitting the first request for obtaining the signed certificate corresponding to each of the first set of services by the first on-premise device, a first on-boarding request may be transmitted by the first on-premise device to the certificate management device. The first on-boarding request may be authenticated by the certificate management device using a first identification code. Authorization with the first on-premise device may be established by the certificate management device. Similarly, prior to transmitting the second request for obtaining the signed certificate corresponding to each of the second set of services by the second on-premise device, a second on-boarding request may be transmitted by the second on-premise device to the certificate management device. The second on-boarding request may be authenticated by the certificate management device using a second identification code. Authorization with the second on-premise device may be established by the certificate management device

In an example, if the output comprises the signed certificate along with the expiration period, a first request for renewal of the signed certificate corresponding to the service may be transmitted to the certificate management device by the first on-premise device upon sending the signed certificate along with the expiration period to the first on-premise device and before a predetermined period of time prior to the expiration period. The first request for renewal may include the first set of parameters corresponding to the service. The first request for renewal may be processed by the signing service of the certificate management device. An output may be generated by using the signing service in response to the processing of the first request for renewal. The output may include a signed certificate along with a new expiration period or a message to reject issuing of a renewed signed certificate.

The output for the first request for the renewal corresponding to each of the first set of services may be sent to the first on-premise device by the certificate management device. Similarly, in an example, if the output comprises the signed certificate along with the expiration period, a second request for renewal of the signed certificate corresponding to the service of the second set of services may be transmitted to the certificate management device by the second on-premise device upon sending the signed certificate along with the expiration period to the second on-premise device and before a predetermined period of time prior to the expiration period. The second request for renewal may include the second set of parameters corresponding to the service. The second request for renewal may be processed by the signing service of the certificate management device. An output for the second request for renewal corresponding to the service may be generated by using the signing service in response to the processing of the first request for renewal.

The output may include a signed certificate along with a new expiration period or a message to reject issuing of a signed certificate. The output for the second request for the renewal corresponding to each of the second set of services may be sent to the second on-premise device by the certificate management device.

In an example, prior to receiving the first request for renewal of the signed certificate by the certificate management device, a token may be transmitted by the first on-premise device. It may be authenticated by the certificate management device if the token received from the first on-premise device is a valid token. In response to the determining that the token is the valid token corresponding to the first on-premise device, the first request for renewal of the signed certificate corresponding to the service may be received from the first on-premise device. Similarly, in an example, prior to receiving the second request for renewal of the signed certificate by the certificate management device, a token may be transmitted by the second on-premise device. It may be authenticated by the certificate management device if the token received from the second on-premise device is a valid token. In response to the ascertaining that the token is the valid token corresponding to the second on-premise device, the second request for renewal of the signed certificate corresponding to the service may be received from the second on-premise device.

The present subject matter provides simple, easy, efficient and reliable techniques for obtaining signed certificates for on-premise devices. With the present subject matter, the process of obtaining certificate for a plurality of services for a plurality of on-premise device may not have to be repeated multiple times for different services using the same certificate or for multiple certificates on the same device. With the present subject matter, signed certificates for each of a set of services corresponding to each of a plurality of on-premise devices can be obtained. Similarly, with the present subject matter, the signed certificates for a plurality of services corresponding to a plurality of on-premise devices can be renewed on a periodic basis without a user having to manage and keep track of the expiration of these certificates. Therefore, the present subject matter eliminates the cumbersome and time-consuming process of having to manage and track expiration periods of various signed certificates by a user, such as a systems integrator. Accordingly, the renewal of the certificates may not be missed. As a result, the present subject matter ensures secure communication between the on-premise devices. The present subject matter eliminates the need for usage of higher amount of resources, such as processing resources, of the on-premise devices for obtaining and renewal of signed certificates, which may otherwise be required for repeating the process of obtaining signed certificate multiple times for different services using the same certificate or for multiple certificates on the same on-premise device.

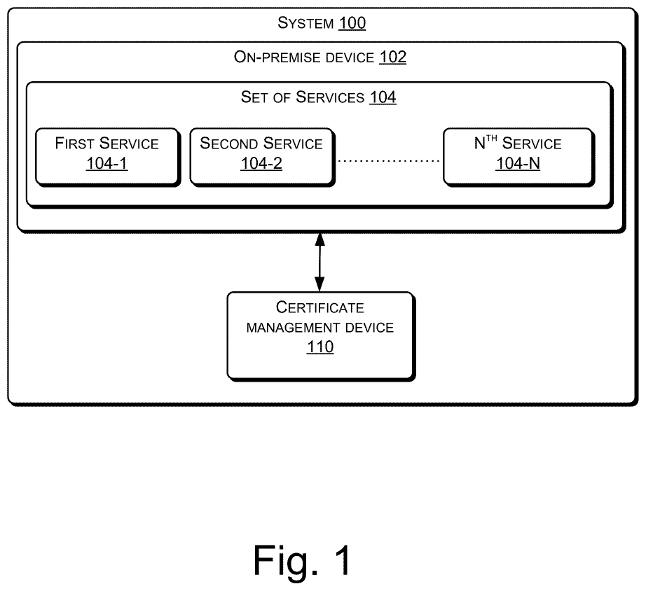

The present subject matter is further described with reference to FIGS. 1-8b. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for obtaining signed certificates for an on-premise device 102, according to an example implementation of the present subject matter. The system 100 may include an on-premise device 102 and may enable obtaining and renewing signed certificates for an on-premise device 102. The on-premise device 102 may be installed on premises (i.e., at a facility, such as a warehouse of an organization). The on-premise device 102 may be, for example, an IoT-based device, such as an IoT-based sensor, a controller, or the like. The on-premise device 102 may be connected in a common object model framework, such as a Niagara Framework. The on-premise device 102 may have to communicate with another on-premise device (not shown in FIG. 1) or with a cloud server (not shown in FIG. 1) for various reasons, such as for controlling another on-premise device, for transmitting data to another on-premise device and/or to cloud server, and the like. For instance, assume that the on-premise device 102 is a controller provided at a manufacturing plant and another on-premise device is an IoT-based temperature sensor to monitor temperature of the manufactured product. The controller may have to communicate with IoT-based temperature sensor to obtain the temperature of the manufactured product and control parameters of the manufacturing process according to the temperature.

In order to enable communication of the on-premise device 102, the on-premise device may include a set of services 104, such as a first service 104-1, a second service 104-2, . . . , N^{th} service 104-n. The set of services 104 may be a web server to enable running of a web page on the on-premise device 102, a Fox protocol server to enable the on-premise device 102 connected in the Niagara framework to communicate with another on-premise device (not shown in FIG. 1) connected in the Niagara framework, platform management service to enable communication regarding management of an operating system corresponding to the on-premise device 102, external communication service to enable communication of the on-premise device 102 outside the system 100. In an example, the first service 104-1 may be a web server to enable running of a web page on the on-premise device 102. The second service 104-2 may be a Fox protocol server to enable the on-premise device 102 connected in the Niagara framework to communicate with another on-premise device connected in the Niagara framework. For instance, assume that the on-premise device 102 is a controller. The controller may include a web server which enables HTTPS communication to that controller (for example, to connect to the controller from a web browser).

To prevent attacks, such as Man-in-The-Middle (MITM) attacks and to enable secure communication of the on-premise device 104, a certificate for each of these services may have to be obtained and signed by an appropriate certificate authority. For instance, the first service 104-1 may require a signed SSL certificate. Similarly, the second service 104-2 may require a signed TLS certificate. The N^{th} service 104-n may require a signed SSL certificate. Further, upon obtaining the signed certificates, the signed certificates will also have to be renewed on a periodic basis.

In this regard, to obtain signed certificates and to renew the signed certificates, the system 100 may include a certificate management device 110. The certificate management device 110 may be connected in the common object model framework, such as Niagara Framework. The certificate management device 110 may be in communication with the on-premise device 102. The certificate management device 110 may be and/or may include a microprocessor, a microcomputer, a microcontroller, a digital signal processor, a central processing unit, a state machine, a logic circuitry, or a device that manipulates signals based on operational instructions. Among other capabilities, the certificate management device 110 may fetch and execute computer-readable instructions stored in a memory, such as a volatile memory or a non-volatile memory, of the certificate management device 110. In operation, the certificate management device 110 may enable to obtain signed certificates for each of the set of services 104 of the on-premise device 102. Particularly, the certificate management device 110 enables the on-premise device 102 to send all requests for obtaining signed certificates together. The certificate management device 110 may process the requests and obtain an output corresponding to each of the set of services 104. In an example, the output may be a signed certificate corresponding to each of the set of services 104 along with an expiration period. The certificate management device 110 may transmit the signed certificates corresponding to each of the set of services 104 to the on-premise device 102. In another example, the output may be a message to reject issuing of a signed certificate. The certificate management device 110 may transmit the message to reject issuing of the signed certificate corresponding to each of the set of services 104 to the on-premise device 102.

In some scenarios, upon sending the signed certificate corresponding to each of the set of services 104, the signed certificate may have to be renewed before expiration period. In this regard, the certificate management device 110 may receive request for renewal of a signed certificate corresponding to a service of the set of services 104 before a predetermined period of time prior to the expiration period. The certificate management device 110 may process the request for renewal to obtain the output for the request for renewal. The output may be, for example, a renewed signed certificate corresponding to the service of a set of services 104 with a new expiration period. In another example, the output may be a message to reject issuing a renewed signed certificate with a new expiration period. The certificate management device 110 may send the output for the request for renewal to the on-premise device 102. In an example, the certificate management device 110 may enable the on-premise device to send all the requests for renewal of the signed certificates corresponding to each of the set of services 104 together and may process all the requests for renewal. While in the above example, the system 100 is illustrated to include a single on-premise device 102, in other examples, the system 100 may include a plurality of on-premise devices and the certificates may be obtained for set of services for each of the plurality of on-premise devices.

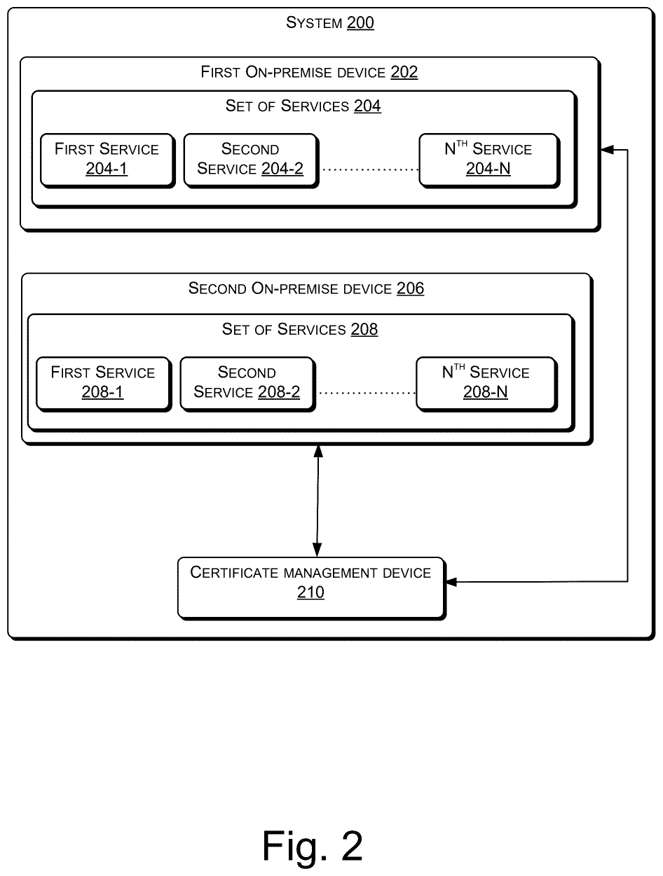

FIG. 2 illustrates a system 200 for obtaining signed certificates for on-premise devices 202, 206, according to an example implementation of the present subject matter. The system 200 may correspond to the system 100. In this example, the system 200 may include a first on-premise device 202 and a second on-premise device 206. The first on-premise device 202 and the second on-premise device 206 may correspond to the on-premise device 102.

The first on-premise device 202 and the second on-premise device 206 may be installed on premises (i.e., at a facility, such as a warehouse of an organization). The first on-premise device 202 and the second on-premise device 206 may be, for example, an IoT-based device, such as an IoT-based sensor, a controller, and the like. The first on-premise device 202 and the second on-premise device 206 may be connected in a common object model framework, such as a Niagara Framework. The first on-premise device 202 and the second on-premise device 206 may have to communicate with each other and/or other on-premise devices (not shown in FIG. 2) or with a cloud server (not shown in FIG. 2) for various reasons. For instance, assume that the first on-premise device 202 is a controller provided at a manufacturing plant and the second on-premise device is a master controller that controls a plurality of controllers in the manufacturing plant. The master controller and the controller may have to communicate with each other to control parameters of the manufacturing process.

To enable communication of the first on-premise device 202, the first on-premise device 202 may include a set of services 204. The set of services 204 may be referred to as the first set of services 204. The first set of services 204 may include such as a first service 204-1, a second service 204-2, . . . , N^{th} service 204-n. Similarly, to enable communication of the second on-premise device 206, the second on-premise device 206 may include a set of services 208. The set of services 208 may be referred to as the second set of services 204. The second set of services may include a first service 208-1, a second service 204-2, . . . , N^{th} service 204-n.

The first set of services 204 and the second set of services 208 may be a web server to enable running of a web page on the corresponding on-premise devices 202, 206, a Fox protocol server to enable the corresponding on-premise device 202, 206 connected in the Niagara framework to communicate with each other or another on-premise device connected in the Niagara framework, platform management service to enable communication regarding management of an operating system corresponding to the on-premise devices 202, 206, external communication service to enable communication of the corresponding on-premise devices 202, 206 outside the system 100. In an example, the first set of services 204 and the second set of services 208 may correspond to the set of services 104.

To obtain signed certificates and to renew the signed certificates corresponding to each of the first set of services 204 and the second set of services 208, the system 200 may include a certificate management device 210. The certificate management device 210 may be connected in the common object model framework, such as Niagara Framework. The certificate management device 210 may be in communication with the first on-premise device 202 and the second on-premise device 206. The certificate management device 210 may be and/or may include a microprocessor, a microcomputer, a microcontroller, a digital signal processor, a central processing unit, a state machine, a logic circuitry, or a device that manipulates signals based on operational instructions. Among other capabilities, the certificate management device 210 may fetch and execute computer-readable instructions stored in a memory, such as a volatile memory or a non-volatile memory, of the certificate management device 210. The certificate management device 210 may correspond to the certificate management device 110.

In operation, the certificate management device 210 may enable to obtain signed certificates for each of the first set of services 204 of the first on-premise device 202 and each of the second set of services 204 of the second on-premise device 206. Particularly, the certificate management device 210 may enable the on-premise devices 202, 206 to send all requests for obtaining signed certificates together. The certificate management device 210 may process the requests and obtain an output corresponding to each of the first set of services 204 and each of the second set of services 208. The output may be a signed certificate corresponding to each of the first set of services 204 along with an expiration period and a signed certificate corresponding to each of the second set of services 208 along with an expiration period. The certificate management device 210 may transmit the signed certificates corresponding to each of the first set of services 204 to the first on-premise device 202 and the signed certificates corresponding to each of the second set of services 208 to the second on-premise device 206. In another example, the output may be a message to reject issuing of a signed certificate. The certificate management device 210 may transmit the message to reject issuing of the signed certificate corresponding to one or more of the first set of services 204 to the first on-premise device 202 and the message to reject issuing of the signed certificate corresponding to one or more of the second set of services 208 to the second on-premise device 206.

In some scenarios, upon sending the signed certificate corresponding to each of the first set of services 204 and each of the second set of services 208, one or more signed certificates may have to be renewed before expiration period. In this regard, the certificate management device 210 may receive request for renewal of a signed certificate corresponding to a service of the first set of services 204 before a predetermined period of time prior to the expiration period. The certificate management device 210 may process the request for renewal to obtain the output for the request for renewal. The output may be, for example, a renewed signed certificate corresponding to the service of the first set of services 204 with a new expiration period. In another example, the output may be a message to reject issuing a renewed signed certificate with a new expiration period. The certificate management device 210 may send the output for the request for renewal to the first on-premise device 202.

Similarly, the certificate management device 210 may receive request for renewal of a signed certificate corresponding to a service of the second set of services 208 before a predetermined period of time prior to the expiration period. The certificate management device 210 may process the request for renewal to obtain the output for the request for renewal. The output may be, for example, a renewed signed certificate corresponding to the service of the second set of services 208 with a new expiration period. In another example, the output may be a message to reject issuing a renewed signed certificate with a new expiration period. The certificate management device 210 may send the output for the request for renewal to the second on-premise device 208.

In an example, the certificate management device 210 may enable the first on-premise device 202 and the second on-premise device 206 to send all the requests for renewal of the signed certificates corresponding to each of first set of services 204 and each of the second set of serviced 208 together and may process all the requests for renewal.

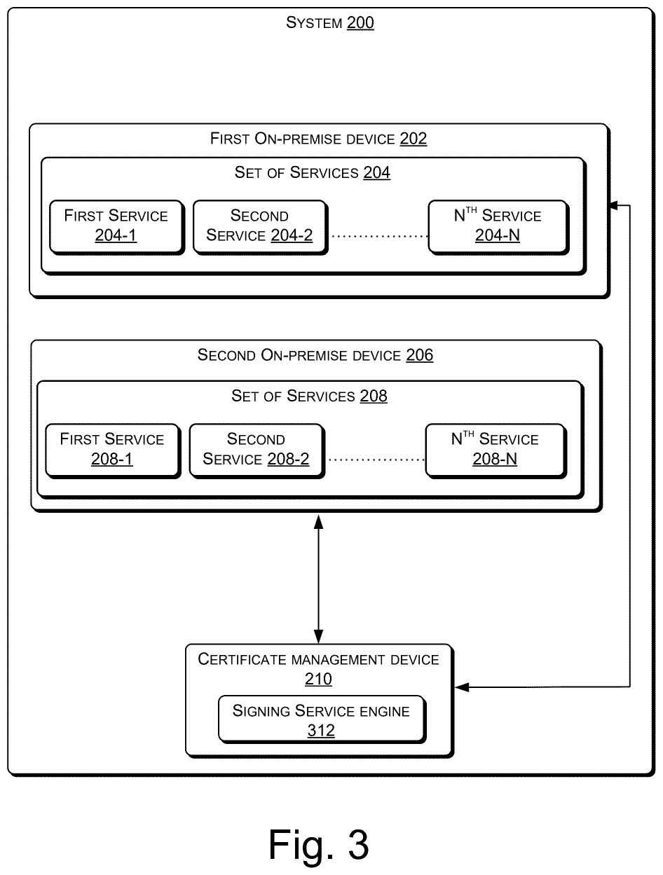

During operation, to obtain the output corresponding to each of the each of the first set of services 204 and each of the second set of services 208, the certificate management device 210 may process the request corresponding to each of the first set of services 204 and each of the second set of services 208. Further, the certificate management device 210 may generate the signed certificates using a signing service, as will be explained with reference to FIG. 3.

For instance, assume that the first service 204-1 may require TLS signed certificate, the second service 204-2 may require SSL signed certificate, and the N^{th} service 204-n may also require TLS signed certificate. Accordingly, the first on-premise device 202 may send the request corresponding to the first service 204-1 (i.e., request for TLS signed certificate), the second service 204-2 (i.e., request for SSL signed certificate), and the N^{th} service 204-n (i.e., request for TLS signed certificate) to the certificate management device 210. The certificate management device 210 may process the request for obtaining the signed certificates corresponding to each of the first set of services 204 and generate the output corresponding to the request for each of the first set of services 204.

The output may be the signed certificate or a message to reject issuing of the signed certificate. For instance, the output corresponding to the first service 204-1 may be a signed certificate for use as TLS certificate. The output corresponding to the second service 204-2 may be a signed certificate corresponding to the second service 204-2 for use as SSL certificate. The output corresponding to N^{th} service 204-n may be a message to reject issuing of the signed certificate for use as TSL certificate.

The certificate management device 210 may transmit the output corresponding to the each of the set of services 204 to the first on-premise device 202. For instance, the certificate management device 210 may transmit, to the first on-premise device 202, the signed certificate corresponding to the first service 204-1 for use as TLS certificate, the signed certificate corresponding to the second service 204-2 for use as SSL certificate, and the message to reject issuing the signed certificate corresponding to the N^{th} service 204-n for use as TLS certificate.

To obtain the output for the request corresponding to each of the second set of services 208, the certificate management device 210 may process the request corresponding to each of the second set of services 208 and each of the second set of services 208. Further, the certificate management device 210 may generate the signed certificates using a signing service, as will be explained with reference to FIG. 3. For instance, assume that the first service 208-1 may require TLS signed certificate, the second service 208-2 may require SSL signed certificate, and the N^{th} service 204-n may also require SSL signed certificate. Accordingly, the second on-premise device 206 may send the request corresponding to the first service 208-1 (i.e., request for TLS signed certificate), the second service 204-2 (i.e., request for SSL signed certificate), and the N^{th} service 204-n (i.e., request for SSL signed certificate). The certificate management device 210 may analyze and process the request for obtaining the signed certificates corresponding to each of the second set of services 208. Further, the certificate management device 210 may generate the output for the request corresponding to each of the second set of services 208 using the signing service.

The output may be the signed certificate or a message to reject issuing of the signed certificate. For instance, the output corresponding to the first service 208-1 may be a message to reject issuing the signed certificate for use as TLS certificate. The output corresponding to the second service 208-2 may be a signed certificate for use as SSL certificate. The output corresponding to the N^{th} service 208-n may be a signed certificate for use as SSL certificate.

The certificate management device 210 may transmit the output corresponding to the each of the second set of services 208 to the second on-premise device 202. For instance, the certificate management device 210 may transmit, to the second on-premise device 202, the message to reject issuing the signed certificate corresponding to the first service 204-1 for use as TLS certificate, the signed certificate corresponding to the N^{th} service 204-n for use as SSL certificate, and the signed certificate corresponding to the second service 204-2 for use as SSL certificate.

Similar to the obtaining of the signed certificates, the process of renewal of the signed certificates may also be done by the certificate management device 210 by processing the request and generating the output corresponding to the request for renewal corresponding to each of the first set of services 202 and each of the second set of services 208 using the signing service.

FIG. 3 illustrates the system 200 for obtaining signed certificates for on-premise devices 202, 206, according to an example implementation of the present subject matter. As mentioned above, in an example, the obtaining and the renewal of the signed certificates can be performed by the certificate management device 210 itself without having to transmit to a certificate authority.

In this regard, the certificate management device 210 may include a plurality of local certificate authority certificates. Each local certificate authority certificate may be signed by a certificate authority's root certificate. The certificate management device 210 may include a signing service engine 312 for signing a certificate. In this regard, to obtain the output for the request corresponding to the first set of services 204, the certificate management device 210 may process the request corresponding to each of the first set of services 204 using at least one of the plurality of local certificate authority certificates by the signing service engine 312. The certificate management device 210 may include the private key for the certificate authority to perform the processing by the certificate management device 210. Further, upon the processing, the output corresponding to request for each of the first set of services 204 may be generated by the certificate management device 210 by using the signing service 312. As explained earlier, the output may be a signed certificate along with an expiration period corresponding to each of the first set of services 204 or a message to reject issuing of a signed certificate corresponding to each of the first set of services 204. For instance, the certificate management device 210 may include a plurality of local certificate authority certificates, such as a local certificate authority certificates in X.509 format that is used for or the necessary encryption or decryption of messages sent using protocols, such as SSL or TLS protocol. Assume that the first service 204-1 may require a TLS signed certificate, the second service 204-2 may require SSL signed certificate, and the N^{th} service 204-n may require SSL signed certificate. Accordingly, the first on-premise device 202 may send the request corresponding to the first service 208-1 (i.e., request for TLS signed certificate), the second service 204-2 (i.e., request for SSL signed certificate), and the N^{th} service 204-n (i.e., request for SSL signed certificate) to the certificate management device 210. The certificate management device 210 may process the request corresponding to each of first set of services 204. In this regard, the certificate management device 210 may generate the output of the signed certificate corresponding to the first service 204-1 for use as TLS certificate by using the signing service engine 312. Further, the certificate management device 210 may generate the output of the signed certificate corresponding to the second service 204-2 by using the signing service engine 312 for use as SSL certificate. Yet further, the certificate management device 210 may generate the output of a message to reject issuing of signed certificate for use as SSL certificate corresponding to the N^{th} service 204-n by using the signing service engine 312. Upon the generation of the output, the output may be sent to the first on-premise device 302. For instance, the certificate management device 312 may send, to the first on-premise device 302, the signed certificate corresponding to the first service 204-1 for use as TLS certificate, the signed certificate corresponding to the second service 204-2 for use as SSL certificate, and the message to reject issuing of the signed certificate corresponding to the N^{th} service 204-n for use as SSL certificate.

To obtain the output for the request corresponding to the second set of services 208, the certificate management device 210 may process the request corresponding to each of the second set of services 208 using at least one of the plurality of local certificate authority certificates by the signing service engine 312. Each local certificate authority certificate may be a root certificate authority certificate, or a certificate signed by a root or intermediate certificate authority that may be configured to be used for signing other certificates. In an example, the certificate management device may be a local certificate authority where rather than signing with a certificate from a root certificate authority, the certificate management device 210 may sign with a locally generated certificate that is trusted by all the on-premise devices the certificate management device signs certificates for. In an example, the certificate management device 210 may process the request using private key for the certificates. In particular, the certificate management device 210 may include private keys for a local certificate authority certificates, for the processing of the request corresponding to each of the second set of services 208. Upon the processing, the output corresponding to request for each of the second set of services 208 may be generated by the certificate management device 210 by using the signing service 310. The output may be a signed certificate along with a expiration period corresponding to each of the second set of services 208 or a message to reject issuing of a signed certificate corresponding to each of the second set of services 204.

Assume that the first service 208-1 may require a TLS signed certificate, the second service 208-2 may require SSL signed certificate, and the N^{th} service 208-n may require SSL signed certificate. Accordingly, the second on-premise device 206 may send the request corresponding to the first service 208-1 (i.e., request for TLS signed certificate), the second service 208-2 (i.e., request for SSL signed certificate), and the N^{th} service 208-n (i.e., request for SSL signed certificate) to the certificate management device 210. The certificate management device 210 may process the request corresponding to each of second set of services 208 to generate the output of the signed certificate corresponding to the first service 208-1 for use as TLS certificate by using the signing service engine 312. Further, the certificate management device 210 may generate the output of the signed certificate corresponding to the second service 208-2 for use as SSL certificate and generate the output of the signed certificate corresponding to the N^{th} service 208-n for use as SSL certificate by using the signing service engine 312. Upon the generation of the output, the output may be sent to the second on-premise device 206. For instance, the certificate management device 210 may send, to the first on-premise device 202, the signed certificate corresponding to the first service 208-1 for use as TLS certificate, the signed certificate corresponding to the second service 208-2 for use as SSL certificate, and the signed certificate corresponding to the N^{th} service 208-n for use as SSL certificate.

Similar to the obtaining of the signed certificates, the process of renewal of the signed certificates may also be done by the certificate management device 210 by processing and generating the signed certificate or a message to reject issuing of signed certificates by itself using the signing service engine 312. Further, upon generating the output, the output corresponding to the first set of services 204 may be sent to the first on-premise device 202 and the output corresponding to the second set of services 208 may be sent to the second on-premise device 204.

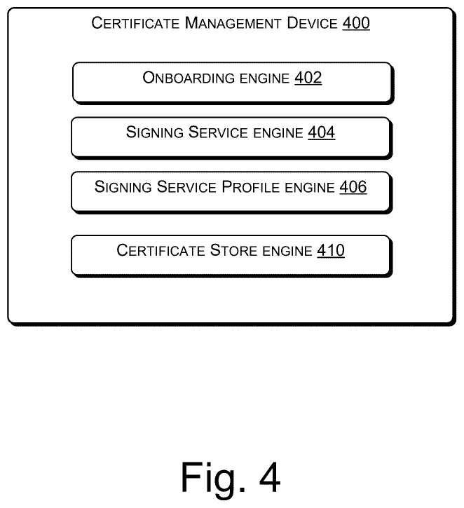

FIG. 4 illustrates a certificate management device 400, according to an example implementation of the present subject matter. The certificate management device 400 may correspond to the certificate management device 110 or the certificate management device 210.

The certificate management device 400 may be or may be part of a computing device that has processing capabilities, such as a server, a desktop, a laptop, a tablet, a mobile phone, or the like. For instance, the certificate management device 400 may include, for example, a microprocessor, a microcomputer, a microcontroller, a digital signal processor, a central processing unit, a state machine, a logic circuitry, or a device that manipulates signals based on operational instructions. Among other capabilities, the processing unit (not shown in FIG. 4) may fetch and execute computer-readable instructions stored in a memory (not shown in FIG. 4), such as a volatile memory or a non-volatile memory, of the device. In an example, the certificate management device 400 may be disposed with in the location of the organization. In another example, the certificate management device 400 may also be disposed outside location of the organization and may be connected to the on-premise device, such as on-premise device 102, on-premise device 202, or the on-premise device 206, through a network.

The certificate management device 400 can include a processing unit (not shown in FIG. 4) to run at least one operating system and other applications and services. The device can also include an interface (not shown in FIG. 4) and a memory (not shown in FIG. 4).

The processing unit, amongst other capabilities, may be configured to fetch and execute computer-readable instructions stored in the memory. The processing unit may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine readable instructions.

When provided by the processing unit, the functions may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface may include a variety of machine-readable instructions-based interfaces and hardware interfaces that allow the cloud communication device to interact with different entities, such as the processing unit, and the data (not shown in FIG. 4). Further, the interface may enable the components of the certificate management device 400 to communicate with on-premise devices, cloud servers, web servers, and external repositories. The interface may facilitate multiple communications within a wide variety of networks and protocol types, including wireless networks, wireless Local Area Network (WLAN), RAN, satellite-based network, and the like.

The memory may be coupled to the processing unit and may, among other capabilities, provide data and instructions for generating different requests. The memory can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

Further, the certificate management device 400 may include one or more engines 402-410. The engines 402-410 may include routines, programs, objects, components, data structures, and the like, which perform particular tasks or implement particular abstract data types. Further, the engines 402-410 may be implemented in hardware, instructions executed by a processing unit, or by a combination thereof.

In an implementation, the engines 402-410 may be machine-readable instructions which, when executed by the processing unit, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 402-410 may perform different functionalities. The engines 402-410 may include an on-boarding engine 402, a signing service engine 404, a signing service profile engine 406, a certificate obtaining engine 408, and a certificate store engine 410.

The on-boarding engine 402 may enable on-boarding of an on-premise device to establish authorization of the on-premise device with the certificate management device 400. The establishing of authorization of the on-premise devices with the certificate management device 400 enables sending the request for obtaining signed certificates to the certificate management devices 400. In an example, to request renewal for signed certificates corresponding to on-premise devices, the on-boarding engine 402 may enable authenticating the request for renewal.

The signing service engine 404 may enable signing the certificates using at least one of the plurality of local certificate authority certificates stored in the memory of the certificate management device 400. Each local certificate authority certificate may be a root certificate authority certificate or a certificate signed by a root or intermediate certificate authority that may be configured to be used for signing other certificates. In an example, the certificate management device may be a local certificate authority where rather than signing with a certificate from a root certificate authority, the certificate management device may sign with a locally generated certificate that is trusted by all the on-premise devices the certificate management device signs certificates for. In an example, the certificate management device 400 may store private keys for various certificate authorities in the memory. The private key may be used by the signing service engine to sign the certificates.

The signing service profile engine 406 may enable validation of the request for obtaining the certificate and validation of request for the renewal of the signed certificates received from the on-premise devices. During the validation, the signing service profile engine 406 may decide whether to provide a signed certificate for the request corresponding to each of the set of services or to reject issuing of the signed certificate. Further, the signed service profile engine 406 may also enable sending the message to reject issuing of the signed certificate.

The certificate store engine 410 may enable storing of the output for the request for obtaining the signed certificates and the output for the request for renewal of the signed certificates. For instance, the certificate store engine 410 may enable storing of the generated and/or renewed signed certificates in the memory of the certificate store engine 410. In a scenario where the certificate is generated by a corresponding certificate authority, the certificate store engine 410 may store the signed certificates generated and/or renewed by the corresponding certificate authority. In both the scenarios, the certificate store engine 410 may also enable storing of the message to reject issuing of the signed certificate and/or the message to reject renewal of the signed certificate.

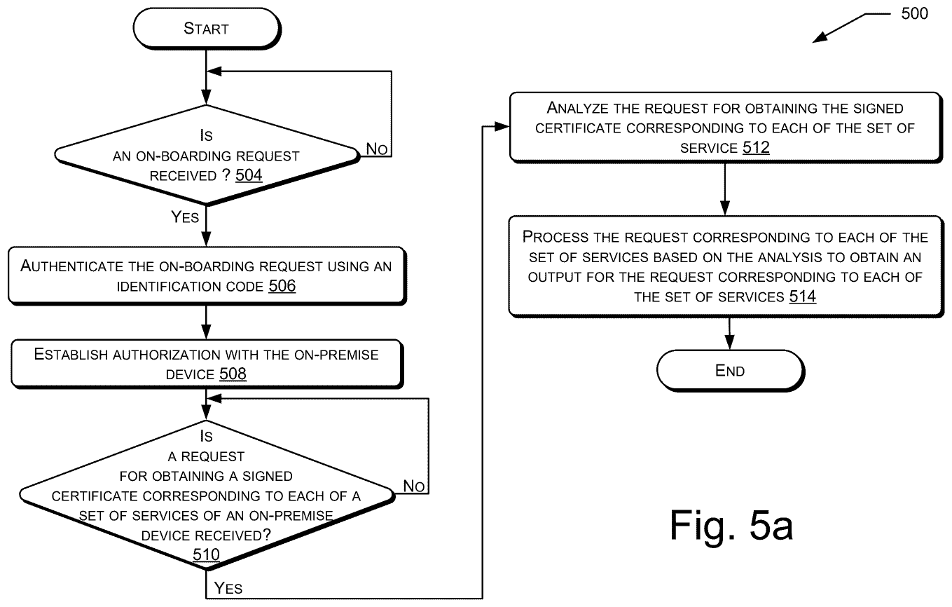

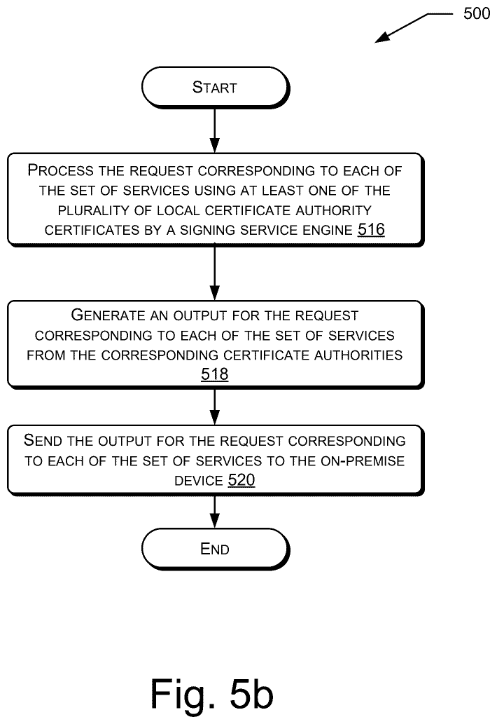

FIGS. 5a-5b illustrate a method 500 for obtaining signed certificates for on-premise devices, according to an example implementation of the present subject matter. The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that steps of the method 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 500 may be performed by the system 100 or the system 200.

At step 504, it may be ascertained if an on-boarding request has been received. The on-boarding request may correspond to the on-boarding of an on-premise device with a certificate management device. The on-premise device may be, for example, the on-premise device 102, the on-premise device 202, or the on-premise device 206. The certificate management device may correspond to the certificate management device 110, the certificate management device 210, or the certificate management device 400. The on-boarding request may enable authorization of the on-premise device with the certificate management device. Once authorized, the on-premise device may be able to send the request for obtaining the signed certificates without having to establish authorization each time for sending the request for obtaining the signed certificates. This prevents wastage of resources (processing resources and processing time) for the on-premise devices, which may otherwise be used for repeatedly sending on-boarding request with the certificate management device each time for requesting a signed certificate.

At step 506, the certificate management device may authenticate the on-boarding request using an identification code. At step 508, the certificate management device may establish authorization with the on-premise device if the authentication is successful. For instance, the certificate management device may ascertain if the identification code is a valid identification code corresponding to the on-premise device. If it is ascertained that the identification code is a valid identification code, the certificate management device may determine that the authentication is successful and establish authorization with the on-premise device. In case it is ascertained that the identification code is not a valid identification code, the certificate management device may determine that the authentication is unsuccessful and may prevent establishing authorization with the on-premise device. The steps 504-508 may be performed by, for example, the on-boarding request engine 402.

At step 510, the certificate management device may ascertain if a request for obtaining a signed certificate corresponding to each of a set of services of the on-premise device is received. The set of services may correspond to the set of services 104, the set of services 204, and/or the set of services 208. The request may include a set of parameters corresponding to each of the set of services. The parameters may indicate type of certificate and a unique identifier corresponding to the on-premise device. The type of certificate may be, for example, a server certificate (for use by a webserver or a fox server), and/or a client certificate (for use by a client sending messages to, for example, Message Queuing Telemetry Transport (MQTT) broker, and the like. The unique identifier may be unique to an on-premise device.

If the request for obtaining the signed certificate corresponding to each of the set of services of the on-premise device is received, the method 500 may proceed to step 512. If the request for obtaining the signed certificate is not received, the method 500 may repeat the step 510.

At step 512, the request for obtaining the signed certificate may be analyzed by the certificate management device. The certificate management device may analyze each of the set of parameters received in the request. For instance, the certificate management device may determine the type of certificate required and the on-premise device that requires the signed certificate by analyzing the request. The analysis may enable processing of the request for obtaining the signed certificate for each of the set of services of the on-premise device.

At step 514, the certificate management device may process the request corresponding to each of the set of services of the on-premise device based on the analysis to obtain an output for the request corresponding to each of the set of services. For instance, assume that the set of parameters corresponding to a first service of the set of services are indicative of a server certificate. Assume that the set of parameters corresponding to a second service of the set of services are indicative of a client certificate. Accordingly, based on the analysis of the request, the certificate management device may ascertain that the first service may require a server certificate and the second service may require a client certificate. The processing of the request may include generation of the output by itself, as will be explained with reference to FIG. 5b. The output may be, for example, a signed certificate with an expiration period or a message to reject issuing of the signed certificate.

FIG. 5b is explained with reference to processing of the request by generating the certificate by the certificate management device. In this regard, at step 516, the certificate management device may process the request corresponding to each of the set of services using at least one of the plurality of local certificate authority certificates. For instance, the certificate management device may include a plurality of local certificate authority certificates in X.509 format that is used sign the certificates that is used for necessary encryption or decryption of messages send using SSL or TLS protocols. The certificate management device may include the private key for certificate authorities to perform the processing by the certificate management device. Assume that the request corresponding to the first service is a signed certificate for use as SSL certificate and the request corresponding to the second service is a signed certificate for use as SSL certificate. The certificate management device may process the request corresponding to the first service using a local certificate authority. Similarly, the certificate management device may process the request corresponding to the second service using a local certificate authority. The step 516 may be performed by the signing service engine 312 or the signing service engine 404 and the signing service profile engine 406.

Further, at step 518, upon the processing, the output corresponding to request for each of the first set of services may be generated by the certificate management device by using the signing service engine. As explained earlier, the output may be a signed certificate along with an expiration period corresponding to each of the set of services or a message to reject issuing of a signed certificate corresponding to each of the set of services. For example, the certificate management device may generate the signed certificate along with the expiration period corresponding to the first request for use as SSL certificate and may generate a message to reject issuing of the signed certificate corresponding to the second service for use as TLS certificate. The generation of the output may be performed by the signing service engine 312 or the signing service engine 408. In an example, subsequent to the generation of the signed certificate, the certificate management device may store the signed certificate in the memory. The certificate store engine 410 may enable storing of the signed certificates.

Further, at step 520, the certificate management device may send the output for the request corresponding to each of the set of service to the on-premise device. For example, the certificate management device may send the signed certificate along with the expiration period (corresponding to the request of the first service) and the message to reject the signed certificate (corresponding to the request of the second service) to the on-premise device.

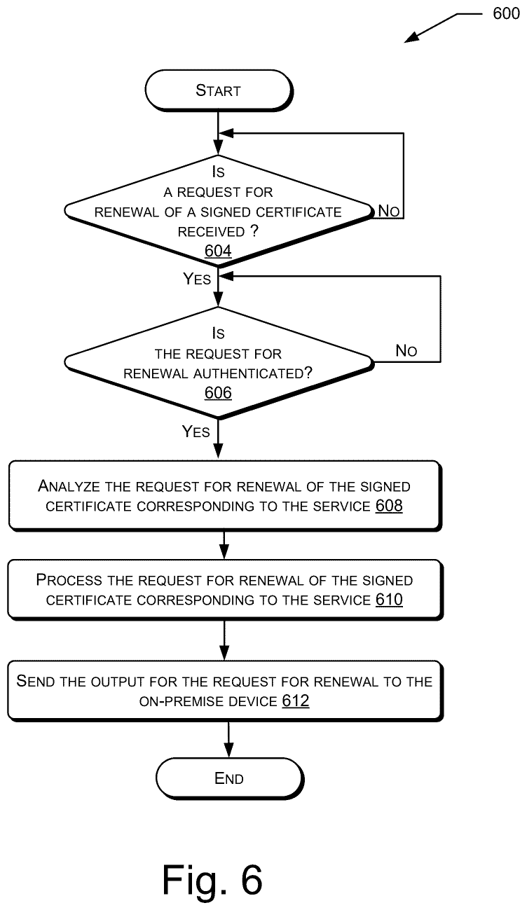

FIG. 6 illustrates a method 600 for renewing the signed certificates for on-premise devices, according to an example implementation of the present subject matter. The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 600 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 600 may be performed by the system 100 or the system 200.

At step 604, it is ascertained if a request for renewal of a signed certificate is received from an on-premise device to a certificate management device. The on-premise device may correspond to the on-premise device 102, the on-premise device 202, or the on-premise device 206. The certificate management device may correspond to the certificate management device 110 or the certificate management device 210. If the request for renewal is not received, the method 600 may repeat the step 604. On the other hand, if the request for renewal of the signed certificate is received from the on-premise device, the method 600 may proceed to step 606. The request for renewal of the signed certificate may be received before a predetermined period of time prior to the expiration period. In an example, the request for renewal of the signed certificate may include a set of parameters being indicative of type of certificate and a unique identifier corresponding to the on-premise device.

At step 606, the certificate management device may determine if the request for renewal of the signed certificate is authenticated. In an example, for the authentication, the certificate management device may receive a token from the on-premise device. The certificate management may determine if the token received from the first on-premise device is a valid token. If the token is a valid token, the certificate management device may determine the authentication to be successful. On the other hand, if the token is not a valid token, the certificate management device may determine that the authentication is unsuccessful and repeats the step 606. On the other hand, if the authentication is successful, the method may proceed to step 608. In an example, the token may be a JavaScript Object Notation (JSON) web token.

At step 608, the certificate management device may analyze the request for renewal of the signed certificate corresponding to the service. The certificate management device may determine the type of certificate required for the renewal and the on-premise device that requires the renewed signed certificate by analyzing the request. The analysis of the request for renewal may be similar to the analysis step 512, as explained with reference to FIG. 5a.

At step 610, the certificate management device may process the request for renewal of the signed certificate corresponding to the service based on the analysis to obtain an output for the request for renewal of the signed certificate. For instance, assume that the request for renewal was received from the first service of the set of services. The request for renewal may be corresponding to a renewal of the signed certificate for use as SSL certificate. Therefore, the request may include a set of parameters that are indicative of the type of certificate and the unique identifier corresponding to the first on-premise device. Accordingly, based on the analysis of the request for renewal, the certificate management device may ascertain that the first service may require renewal of the signed certificate for use as SSL certificate.

The processing of the request for renewal may be similar to the processing step 514, as explained with reference to FIG. 5a. In particular, the processing of the request for renewal of the signed certificate corresponding to the service may be similar to the steps 516-518, as explained with reference to FIG. 5b.

By processing, an output corresponding to the request for renewal may be obtained. The output may be, for example, a renewed signed certificate with a new expiration period. In another example, the output may be a message to reject renewal of the signed certificate.

For example, in such a scenario, the certificate management device may process the request for renewal of the signed certificate corresponding to first service using a local certificate authority certificate. The certificate management device may include the private key to perform the processing by the certificate management device. The certificate management device may generate the renewed signed certificate along with the new expiration period corresponding to the first service for use as SSL certificate. The certificate management device may enable storing of the renewed signed certificate along with the new expiration period in the memory of the certificate management device using certificate storing engine 410.

At step 612, the output corresponding to the request for renewal may be sent to the on-premise device by the certificate management device. For example, the certificate management device may send the renewed signed certificate along with the new expiration period to the on-premise device that may be used by the on-premise device as SSL certificate.

In the above examples explained with reference to FIGS. 5a-6, the on-premise device is explained with reference to a single on-premise device. However, as will be apparent, there may be a plurality of on-premise devices. Further, the request for obtaining signed certificates and request for renewal of the signed certificates can be performed corresponding to each of the set of services for each of the plurality of on-premise devices with the same steps as explained with reference to FIGS. 5a-6.

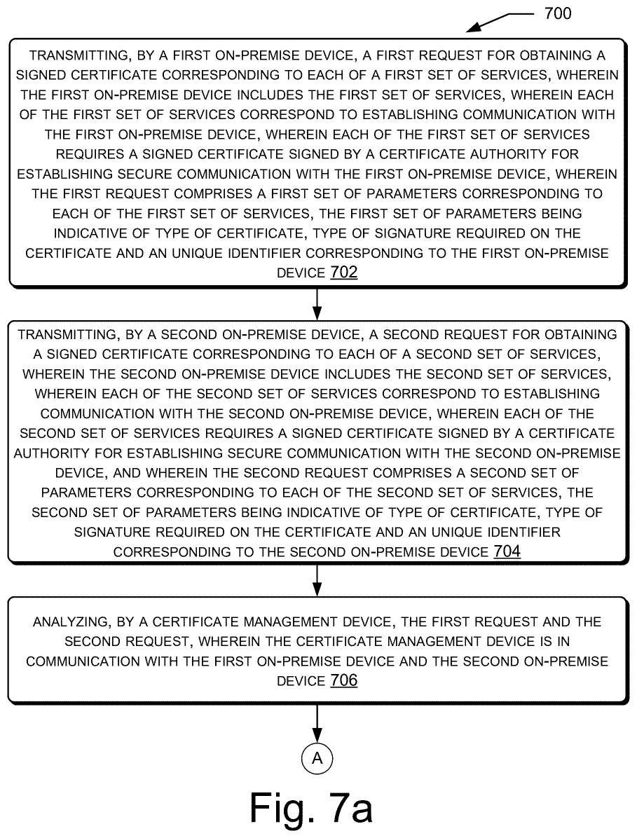

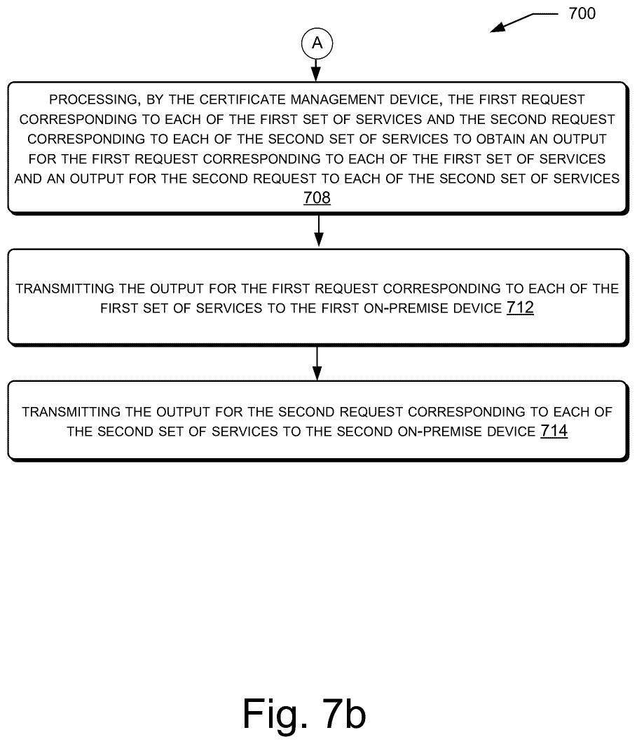

FIGS. 7a-7b illustrate a method 700 for obtaining signed certificates for on-premise devices, according to an example implementation of the present subject matter. The order in which the method 700 is described is not intended to be construed as a limitation, and any number of the described method blocks may be combined in any order to implement the method 700, or an alternative method. Furthermore, the method 700 may be implemented by processor(s) or computing device(s) through any suitable hardware, non-transitory machine-readable instructions, or a combination thereof.

It may be understood that steps of the method 700 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 700 may be performed by the system 100 or the system 200.

At step 702, the method 700 includes transmitting, by a first on-premise device, a first request for obtaining a signed certificate corresponding to each of a first set of services. The first on-premise device may include the first set of services. Each of the first set of services may correspond to establishing communication with the first on-premise device. Each of the first set of services requires a signed certificate signed by a certificate authority for establishing secure communication with the first on-premise device. The first request may include a first set of parameters corresponding to each of the first set of services. The first set of parameters may be indicative of type of certificate and an unique identifier corresponding to the first on-premise device. The first on-premise device may correspond to the on-premise device 102 or the first on-premise device 202. The first set of service may correspond to the set of services 104 or the first set of services 204.

At step 704, a second request for obtaining a signed certificate corresponding to each of a second set of services may be transmitted by a second on-premise device. The second on-premise device may include the second set of services. Each of the second set of services may correspond to establishing communication with the second on-premise device. Each of the second set of services may requires a signed certificate signed by a certificate authority for establishing secure communication with the second on-premise device. The second request may include a second set of parameters corresponding to each of the second set of services. The second set of parameters may be indicative of type of certificate and a unique identifier corresponding to the second on-premise device. The second on-premise device may correspond to the on-premise device 102 or the second on-premise device 206. The second set of services may correspond to the set of services 104 or the second set of services 208.

In an example, the first set of services and the second set of services may be a web server to enable running of a web page on the on-premise device, a Fox protocol server to enable the on-premise device to communicate with another on-premise device, platform management service to enable communication regarding management of an operating system level details corresponding to the on-premise device, external communication service to enable communication of the on-premise device outside the system.

At step 706, the first request and the second request for obtaining the certificate corresponding to each of the first set of services and to each of the second set of services may be analyzed by the certificate management device. The certificate management device may be in communication with the first on-premise device and the second on-premise device. The certificate management device may correspond to the certificate management device 110 or the certificate management device 210. The analysis of the first request and the second request will be performed, as explained with reference to FIG. 5a.

Referring to FIG. 7b, at step 708, the first request corresponding to each of the first set of services and the second request corresponding to each of the second set of services may be processed to obtain an output for the first request and an output for the second request. The step 708 may be similar to the steps 516 and 518, as explained with reference to FIG. 5b.

At step 712, the output for the first request corresponding to each of the first set of services may be transmitted by the certificate management device to the first on-premise device. At step 714, the output for the second request corresponding to each of the second set of services may be transmitted by the certificate management device to the second on-premise device. The steps 712-714 may be similar to the step 520, as explained with reference to FIG. 5b.

In an example, the certificate management device may include a plurality of local certificate authority certificates. Each local certificate authority certificate may be signed by a certificate authority's root certificate. The certificate management device may include a signing service engine for signing a certificate. To obtain the output for the first request corresponding to each of the first set of services and the output for the second request corresponding to each of the second set of services, the method may include the following steps:

The first request corresponding to each of the first set of services and the second request corresponding to each of the second set of services may be processes by the signing service engine of the certificate management device using at least one of the plurality of local certificate authority certificates.

The output for the first request and the output for the second request may be generated by the signing service engine of the certificate management device. The output for the first request and the output for the second request may be a signed certificate along with the expiration period or a message to reject issuing of a signed certificate for the first request.

In an example, prior to transmitting the first request for obtaining the signed certificate corresponding to each of the first set of services by the first on-premise device, the method 700 may include transmitting, by the first on-premise device, a first on-boarding request. The first on-boarding request may be authenticated by the certificate management device using a first identification code. Authorization with the first on-premise device may be established by the certificate management device if the authentication is successful, as explained with reference to FIG. 5a.

Similarly, prior to transmitting the second request for obtaining the signed certificate corresponding to each of the second set of services by the second on-premise device, the method 700 may include transmitting, by the second on-premise device, a second on-boarding request. The second on-boarding request may be authenticated by the certificate management device using a second identification code. Authorization with the second on-premise device may be established by the certificate management device if the authentication is successful, as explained with reference to FIG. 5a.

In an example, the method 700 may include requesting, by the first on-premise device, the output for the first request corresponding to each of the first set of services to the first on-premise device. Further, the output for the first request corresponding to each of the first set of services may be transmitted, by the certificate management device, to the first on-premise device in response to the requesting by the first on-premise device. The output for the second request corresponding to each of the second set of services may be requested by the second on-premise device. The output for the second request corresponding to each of the second set of services may be transmitted, by the certificate management device, to the second on-premise device in response to the requesting by the second on-premise device.

In an example, if the output includes the signed certificate along with the expiration period, upon sending the signed certificate along with the expiration period to the first on-premise device, the method 700 includes the following steps:

A first request for renewal of the signed certificate corresponding to the service may be transmitted by the first on-premise device. The first request for renewal may include the first set of parameters corresponding to the service. The first request for renewal of the signed certificate may be received before a predetermined period of time prior to the expiration period.

The first request for renewal of the signed certificate corresponding to the service may be analyzed by the certificate management device. The first request for renewal corresponding to service may be processed, by the signing service engine of the certificate management device, to a corresponding certificate authority based on the analysis. An output for the first request for the renewal corresponding to the service from the corresponding certificate authorities may be generated by the signing service engine. The output may include a signed certificate along with a new expiration period or a message to reject issuing of a renewed signed certificate. The output for the first request for the renewal corresponding to each of the first set of services may be sent, by the certificate management device, to the first on-premise device.

In an example, prior to receiving the first request for renewal of the signed certificate by the certificate management device, a token may be transmitted by the first on-premise device to the certificate management device. The method 700 may include authenticating, by the certificate management device, if the token received from the first on-premise device is a valid token. The first request for renewal of the signed certificate corresponding to the service may be received from the first on-premise device in response to the authenticating that the token is the valid token.

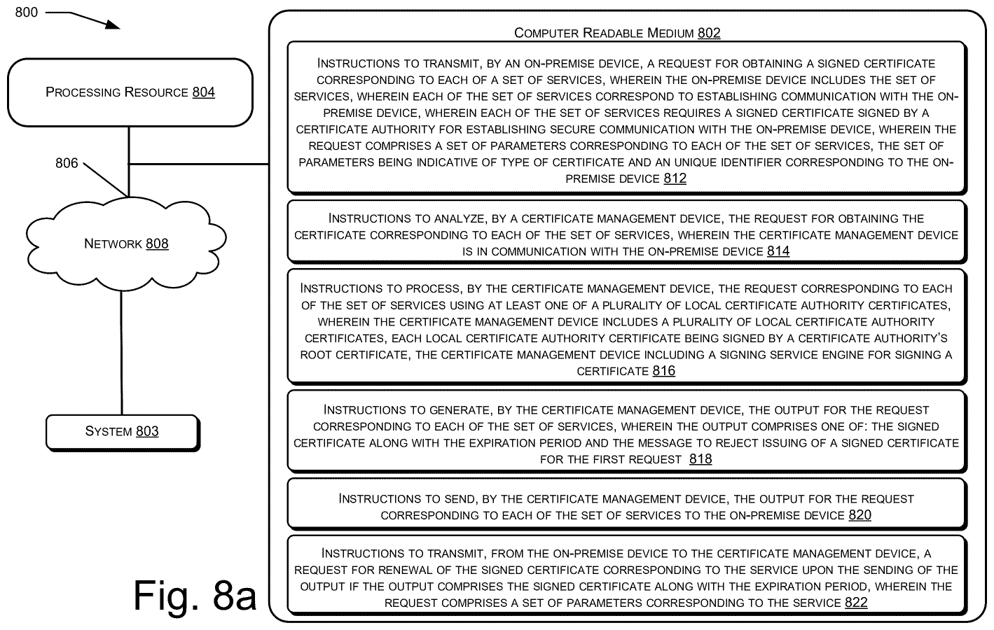

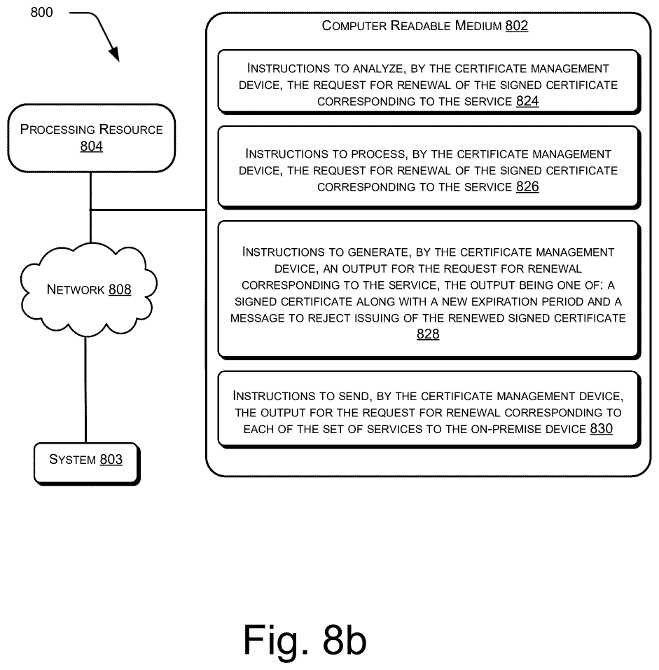

FIGS. 8a-8b illustrates a computing environment 800, implementing a non-transitory computer-readable medium for obtaining signed certificates for on-premise devices, according to an example implementation of the present subject matter.

In an example, the non-transitory computer-readable medium 802 may be utilized by the system 803. The system 803 may correspond to the system 100 or the system 200. The system 803 may be implemented in a public networking environment or a private networking environment. In an example, the computing environment 800 may include a processing resource 804 communicatively coupled to the non-transitory computer-readable medium 802 through a communication link 806.

In an example, the processing resource 804 may be implemented in a device, such as the system 803. The non-transitory computer-readable medium 802 may be, for example, an internal memory device of the server device 803 or an external memory device. In an implementation, the communication link 806 may be a direct communication link, such as any memory read/write interface. In another implementation, the communication link 806 may be an indirect communication link, such as a network interface. In such a case, the processing resource 804 may access the non-transitory computer-readable medium 802 through a network 808. The network 808 may be a single network or a combination of multiple networks and may use a variety of different communication protocols. The processing resource 804 and the non-transitory computer-readable medium 802 may also be communicatively coupled to the system 803 over the network 808.

In an example implementation, the non-transitory computer-readable medium 802 includes a set of computer-readable instructions to obtain signed certificates for on-premise devices. The set of computer-readable instructions can be accessed by the processing resource 804 through the communication link 806 and subsequently executed to perform acts to provide feedback to the actuating object.

Referring to FIG. 8a, in an example, the non-transitory computer-readable medium 802 includes instructions 812 to transmit, by an on-premise device, a request for obtaining a signed certificate corresponding to each of a set of services. The on-premise device may include the set of services. Each of the set of services may correspond to establishing communication with the on-premise device. Each of the set of services requires a signed certificate signed by a certificate authority for establishing secure communication with the on-premise device. The request may include a set of parameters corresponding to each of the set of services. The set of parameters may be indicative of type of certificate and an unique identifier corresponding to the on-premise device. The on-premise device may correspond to the on-premise device 102, the on-premise device 202, or the on-premise device 206. The first set of services may correspond to the set of services 104, the set of services 204, or the set of services 208.

The non-transitory computer-readable medium 802 includes instructions 814 to analyze, by a certificate management device, the request for obtaining the certificate corresponding to each of the set of services. The certificate management device may be in communication with the on-premise device. The certificate management device may correspond to the certificate management device 110 or the certificate management device 210. The analysis may be similar to the analysis of step 512, as explained with reference to FIG. 5a.

The non-transitory computer-readable medium 802 includes instructions 816 to process, by the certificate management device, the request corresponding to each of the set of services using at least one of a plurality of local certificate authority certificates. The certificate management device may include a plurality of local certificate authority certificates. Each local certificate authority certificate may be signed by a certificate authority's root certificate. The certificate management device may include a signing service engine for signing a certificate.

The non-transitory computer-readable medium 802 includes instructions 818 to generate, by the certificate management device, the output for the request corresponding to each of the set of services. The output may be the signed certificate along with the expiration period or the message to reject issuing of a signed certificate for the request.

The non-transitory computer-readable medium 802 includes instructions 820 to send, by the certificate management device, the output for the request corresponding to each of the set of services to the on-premise device. The instructions 816-820 may correspond to the steps 516-520, as explained with reference to FIG. 5b.

The non-transitory computer-readable medium 802 includes instructions 822 to transmit, from the on-premise device to the certificate management device, a request for renewal of the signed certificate corresponding to the service upon the sending of the output if the output comprises the signed certificate along with the expiration period. The request may include a set of parameters corresponding to the service. The set of parameters may be indicative of type of certificate and an unique identifier corresponding to the on-premise device.

Referring to FIG. 8b, the non-transitory computer-readable medium 802 includes instructions 824 to analyze, by the certificate management device, the request for renewal of the signed certificate corresponding to the service. The non-transitory computer-readable medium 802 includes instructions 826 to process, by the certificate management device, the request for renewal of the signed certificate corresponding to the service.

The non-transitory computer-readable medium 802 includes instructions 828 to generate, by the certificate management device, an output for the request for renewal corresponding to the service. The output may be a signed certificate along with a new expiration period and a message to reject issuing of the renewed signed certificate.

The non-transitory computer-readable medium 802 includes instructions 830 to send, by the certificate management device, the output for the request for renewal corresponding to each of the set of services to the on-premise device.

The non-transitory computer-readable medium 802 includes instructions to transmit, from the on-premise device, the request for renewal of the signed certificate before a predetermined period of time prior to the expiration period. If the output comprises the signed certificate along with the expiration period, the non-transitory computer-readable medium 802 includes the instructions to determine, by the certificate management device, if the request for renewal of the signed certificate corresponding to the service is received from the on-premise device within a grace period of time after elapsing of the expiration period. Further, the non-transitory computer-readable medium 802 includes the instructions to analyze, by the certificate management device, the request for renewal of the signed certificate corresponding to the service if the request for renewal is received from the on-premise device within the grace period of time after elapsing of the expiration period.

The present subject matter provides simple, easy, efficient and reliable techniques for obtaining signed certificates for on-premise devices. With the present subject matter, the process of obtaining certificate for a plurality of services for a plurality of on-premise devices may not have to be repeated multiple times for different services using the same certificate or for multiple certificates on the same device. In particular, with the present subject matter, signed certificates for each of the set of services for each of a plurality of on-premise devices can be obtained. Similarly, with the present subject matter, the signed certificates for a plurality of services for a plurality of on-premise devices can be renewed on a periodic basis without a user having to manage and keep track of the expiration of these certificates. Therefore, the present subject matter eliminates the cumbersome and time-consuming process of having to manage and track expiration periods of various signed certificates by a user, such as a systems integrator. Accordingly, the renewal of the certificates may not be missed. As a result, the present subject matter ensures secure communication between the on-premise devices. The present subject matter eliminates the need for usage of higher amount of resources, such as processing resources, for the on-premise devices for obtaining and renewal of signed certificates, which may otherwise be required for repeating the process of obtaining signed certificate multiple times for different services using the same certificate or for multiple certificates on the same on-premise device.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. A system for obtaining signed certificates for on-premise devices, the system comprising:
an on-premise device, wherein the on-premise device includes a set of services, wherein each service corresponds to establishing communication with the on-premise device, wherein each service requires a certificate signed by a certificate authority for establishing secure communication with the on-premise device;
a certificate management device in communication with the on-premise device, wherein the certificate management device is to:
receive, from the on-premise device, a request for obtaining a signed certificate corresponding to each of the set of services, wherein the request comprises a set of parameters corresponding to each of the set of services, the parameters being indicative of type of certificate and a unique identifier corresponding to the on-premise device;
analyze the request for obtaining the signed certificate corresponding to each of the set of services;
process the request corresponding to each of the set of services based on the analysis to obtain an output for the request corresponding to each of the set of services, wherein the output comprises one of: a signed certificate of a corresponding certificate authority along with an expiration period and a message to reject issuing of a signed certificate; and
send the output for the request corresponding to each of the set of services to the on-premise device.

2. The system of claim 1, wherein the certificate management device includes a plurality of local certificate authority certificates, each local certificate authority certificates being signed by a certificate authority's root certificate, the certificate management device includes a signing service for signing a certificate, wherein to obtain the output for the request corresponding to each of the set of services, the certificate management device is to:
process, by the signing service, the request corresponding to each of the set of services using at least one of the plurality of local certificate authority certificates; and
generate, by using the signing service, the output of one of: the signed certificate along with the expiration period and the message to reject issuing of a signed certificate.

3. The system of claim 1, wherein prior to receiving the request for obtaining the signed certificate corresponding to each of the set of services, the certificate management device is to:
receive, from the on-premise device, an on-boarding request;
authenticate the on-boarding request using an identification code; and
establish authorization with the on-premise device.

4. The system of claim 1, wherein if the output comprises the signed certificate along with the expiration period, upon sending the signed certificate along with the expiration period to the on-premise device, the certificate management device is to:
receive, from the on-premise device, a request for renewal of the signed certificate corresponding to the service, wherein the request comprises a set of parameters corresponding to the service, wherein the request for renewal of the signed certificate is to be received before a predetermined period of time prior to the expiration period;
analyze the request for renewal of the signed certificate corresponding to the service in response to receiving the request for renewal of the signed certificate corresponding to the service;
process, by a signing service, the request for renewal of the signed certificate corresponding to the service, wherein the certificate management device includes a plurality of local certificate authority certificates, each local certificate authority certificates being signed by a certificate authority's root certificate, the certificate management device includes the signing service for signing a certificate;
generate, by using the signing service, the output of one of: a signed certificate along with a new expiration period and a message to reject issuing of the signed certificate; and
send the output for the request for renewal to the on-premise device.

5. The system of claim 4, wherein prior to receiving the request for renewal of the signed certificate corresponding to the service, the certificate management device is to:
authenticate the request for renewal using a token; and
receive, from the on-premise device, the request for renewal of the signed certificate corresponding to the service in response to a successful authentication.

6. The system of claim 5, wherein the token is a JavaScript Object Notation (JSON) web token.

7. The system of claim 1, wherein the set of services is one of: a web server to enable running of a web page on the on-premise device, a Fox protocol server to enable the on-premise Niagara device to communicate with another on-premise Niagara device, platform management service to enable communication regarding management of an operating system corresponding to the on-premise device, external communication service to enable communication of the on-premise device outside the system.

8. The system of claim 1, wherein the signed certificate is one of: a X.509 certificate for use as a client certificate and a X.509 certificate for use as a server certificate.

9. The system of claim 1, wherein if the output comprises the signed certificate along with the expiration period, the on-premise device is to:
store the signed certificate along with the expiration period upon receiving the output from the certificate management device; and
update configuration corresponding to each of the set of the services to present the stored signed certificate.

10. A method for obtaining signed certificates for an on-premise device, the method comprising:
transmitting, by a first on-premise device, a first request for obtaining a signed certificate corresponding to each of a first set of services, wherein the first on-premise device includes the first set of services, wherein each of the first set of services correspond to establishing communication with the first on-premise device, wherein each of the first set of services requires a signed certificate signed by a certificate authority for establishing secure communication with the first on-premise device, wherein the first request comprises a first set of parameters corresponding to each of the first set of services, the first set of parameters being indicative of type of certificate and an unique identifier corresponding to the first on-premise device;
transmitting, by a second on-premise device, a second request for obtaining a signed certificate corresponding to each of a second set of services, wherein the second on-premise device includes the second set of services, wherein each of the second set of services correspond to establishing communication with the second on-premise device, wherein each of the second set of services requires a signed certificate signed by a certificate authority for establishing secure communication with the second on-premise device, and wherein the second request comprises a second set of parameters corresponding to each of the second set of services, the second set of parameters being indicative of type of certificate and an unique identifier corresponding to the second on-premise device;
analyzing, by a certificate management device, the first request and the second request, wherein the certificate management device is in communication with the first on-premise device and the second on-premise device;
processing, by the certificate management device, the first request corresponding to each of the first set of services and the second request corresponding to each of the second set of services to obtain an output for the first request corresponding to each of the first set of services and an output for the second request to each of the second set of services;
transmitting the output for the first request corresponding to each of the first set of services to the first on-premise device; and
transmitting the output for the second request corresponding to each of the second set of services to the second on-premise device.

11. The method of claim 10, wherein the certificate management device includes a plurality of local certificate authority certificates, each local certificate authority certificate being signed by a certificate authority's root certificate, the certificate management device includes a signing service engine for signing a certificate, wherein to obtain the output for the first request corresponding to each of the first set of services and the output for the second request corresponding to each of the second set of services, the certificate management device is to:
processing, by the signing service engine of the certificate management device, the first request corresponding to each of the first set of services and the second request corresponding to each of the second set of services using at least one of the plurality of local certificate authority certificates; and
generating, by the signing service engine of the certificate management device, the output for the first request and the output for the second request, the output for the first request and the output for the second request being one of: the signed certificate along with the expiration period and the message to reject issuing of a signed certificate for the first request.

12. The method of claim 10, wherein prior to transmitting the first request for obtaining the signed certificate corresponding to each of the first set of services by the first on-premise device, the method comprises:
transmitting, by the first on-premise device, a first on-boarding request;
authenticating, by the certificate management device, the first on-boarding request using a first identification code; and
establishing, by the certificate management device, authorization with the first on-premise device.

13. The method of claim 10, wherein prior to transmitting the second request for obtaining the signed certificate corresponding to each of the second set of services by the second on-premise device, the method comprises:
transmitting, by the second on-premise device, a second on-boarding request;
authenticating, by the certificate management device, the second on-boarding request using a second identification code; and
establishing, by the certificate management device, authorization with the second on-premise device.

14. The method of claim 10, comprising:
requesting, by the first on-premise device, the output for the first request corresponding to each of the first set of services to the first on-premise device;
transmitting, by the certificate management device, the output for the first request corresponding to each of the first set of services to the first on-premise device in response to the requesting by the first on-premise device;
requesting, by the second on-premise device, the output for the second request corresponding to each of the second set of services; and
transmitting, by the certificate management device, the output for the second request corresponding to each of the second set of services to the second on-premise device in response to the requesting by the second on-premise device.

15. The method of claim 11, wherein if the output comprises the signed certificate along with the expiration period, upon sending the signed certificate along with the expiration period to the first on-premise device, the method comprises:
transmitting, by the first on-premise device, a first request for renewal of the signed certificate corresponding to the service, wherein the first request for renewal comprises the first set of parameters corresponding to the service, wherein the first request for renewal of the signed certificate is to be received before a predetermined period of time prior to the expiration period;
analyzing, by the certificate management device, the first request for renewal of the signed certificate corresponding to the service;
processing, by the signing service engine of the certificate management device, the first request for renewal of the signed certificate corresponding to the service;
generating, by using the signing service, an output for the first request for renewal, the output being one of: a signed certificate along with a new expiration period and a message to reject issuing of the renewed signed certificate; and
sending, by the certificate management device, the output for the first request for renewal to the first on-premise device.

16. The method of claim 10, wherein prior to receiving the first request for renewal of the signed certificate by the certificate management device, the method comprises:
transmit, by the first on-premise device, a token;
authenticating, by the certificate management device, if the token received from the first on-premise device is a valid token; and
receive, from the first on-premise device, the first request for renewal of the signed certificate corresponding to the service in response to the authenticating that the token is the valid token.

17. The method of claim 10, wherein the first set of services and the second set of services is one of: a web server to enable running of a web page on the on-premise device, a Fox protocol server to enable the on-premise device to communicate with another on-premise device, platform management service to enable communication regarding management of an operating system level details corresponding to the on-premise device, external communication service to enable communication of the on-premise device outside the system.

18. A non-transitory computer-readable medium comprising instructions for obtaining signed certificates for on-premise devices, the instructions being executable by a processing resource to:
transmit, by an on-premise device, a request for obtaining a signed certificate corresponding to each of a set of services, wherein the on-premise device includes the set of services, wherein each of the set of services correspond to establishing communication with the on-premise device, wherein each of the set of services requires a signed certificate signed by a certificate authority for establishing secure communication with the on-premise device, wherein the request comprises a set of parameters corresponding to each of the set of services, the set of parameters being indicative of type of certificate and an unique identifier corresponding to the on-premise device;
analyze, by a certificate management device, the request for obtaining the certificate corresponding to each of the set of services, wherein the certificate management device is in communication with the on-premise device;
process, by the certificate management device, the request corresponding to each of the set of services using at least one of a plurality of local certificate authority certificates, wherein the certificate management device includes a plurality of local certificate authority certificates, each local certificate authority certificate being signed by a certificate authority's root certificate, the certificate management device including a signing service engine for signing a certificate;
generate, by the certificate management device, the output for the request corresponding to each of the set of services, wherein the output comprises one of: the signed certificate along with the expiration period and the message to reject issuing of a signed certificate for the request;
send, by the certificate management device, the output for the request corresponding to each of the set of services to the on-premise device;
transmit, from the on-premise device to the certificate management device, a request for renewal of the signed certificate corresponding to the service upon the sending of the output if the output comprises the signed certificate along with the expiration period, wherein the request comprises a set of parameters corresponding to the service;
analyze, by the certificate management device, the request for renewal of the signed certificate corresponding to the service;
process, by the certificate management device, the request for renewal of the signed certificate corresponding to the service;
generate, by the certificate management device, an output for the request for renewal corresponding to the service, the output being one of: a signed certificate along with a new expiration period and a message to reject issuing of the renewed signed certificate; and
send, by the certificate management device, the output for the request for renewal corresponding to the service to the on-premise device.

19. The non-transitory computer-readable medium of claim 18, the instructions being executable by the processing resource to:
transmit, from the on-premise device, the request for renewal of the signed certificate before a predetermined period of time prior to the expiration period.

20. The non-transitory computer-readable medium of claim 18, wherein if the output comprises the signed certificate along with the expiration period, the instructions being executable by the processing resource to:
determine, by the certificate management device, if the request for renewal of the signed certificate corresponding to the service is received from the on-premise device within a grace period of time after elapsing of the expiration period; and
analyze, by the certificate management device, the request for renewal of the signed certificate corresponding to the service if the request for renewal is received from the on-premise device within the grace period of time after elapsing of the expiration period.
